(19) United States
(12) Patent Application Publication
(10) Pub. No.: US 2018/0300034 A1
(43) Pub. Date: Oct. 18, 2018

(54) Systems to improve how graphical user interfaces can present rendered worlds in response to varying zoom levels and screen sizes

(71) Applicant: Suzanne Kimberly Taylor, Upper Saddle River, NJ (US)

(72) Inventor: Suzanne Kimberly Taylor, Upper Saddle River, NJ (US)

(21) Appl. No.: 15/952,160

(22) Filed: Apr. 12, 2018

Related U.S. Application Data
(60) Provisional application No. 62/484,627, filed on Apr. 12, 2017.

(51) Int. Cl. G06F 3/0485; G06F 3/0484

(52) U.S. Cl. CPC G06F 3/0485; G06F 2203/04808; G06F 2203/04806; G06F 3/04845

(57) ABSTRACT

Systems that will allow users to navigate and explore a rendered world, at a range of screen size to world size ratios, including a system by which each scene that presents a portion of the rendered world is, unlike prior art, optimized for immediate game play, interpretation and/or interaction and for user awareness of context given the user's chosen screen size and zoom level, a system to help users to navigate more effectively when the screen size to world size ratio is so low that navigation becomes difficult and systems to provide both context and visual access even when the screen size to world size ratio is so low that only one, or even just a portion of one, item can be displayed visually.

### CROSS-REFERENCE TO RELATED APPLICATIONS

This application claims the benefit of United States provisional patent application with application No. 62/484,627, filed Apr. 12, 2017 by the present inventor, which is incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to information technology accessibility, and more specifically to game accessibility.

### BACKGROUND

For many years, people with visual impairments and other disabilities have used innovative methods for accessing information technology. This includes zoom, text-to-speech, speech input, sound effects, and haptics. In addition, people with and without disabilities are using more and more diverse devices, device sizes and input/output methods. Overall, this means that zoom is being used increasingly, and that the ratio between the screen size and the size of the overall content being displayed is generally decreasing.

However, often zooming in, using a screen that is considerably smaller than the screen used to design the content, or both can leave the user:
lost in blank or empty space,
trying to interpret something that is too small to fully take in,
or experiencing only an unintelligible piece of an item.
   The visual image shown has often been whatever is derived naturally from simply increasing or decreasing the size of the content uniformly and is often jarring, incomplete and unpolished as the scene is not laid out and adjusted for the particular situation.

The issues that arise from allowing zoom to work naturally on information technology can be frustrating on ordinary Web pages and apps, which typically present distinct items such as paragraphs of text, form fields, images and video. However, users can still make use of ordinary Web pages and apps when this happens. In addition, there are currently techniques in prior art that at least partially correct this issue for ordinary Web pages and apps. These existing techniques include responsive design for stepped adjustments to Web sites, auto layout in iOS, smart zoom in browsers and liquid design for continuous adjustments in Web sites.

But, for static, animated and/or interactive rendered worlds (such as video game worlds, simulated environments, and sociological maps), the issues that arise from allowing zoom to work naturally go beyond causing frustration and can be fully inhibiting.

In fact, the experience is commonly so bad and unresolvable through prior art that zoom and the ability to change display orientation and this type of information technology have been substantially assumed incompatible. As a result, zoom and the ability to change the display orientation are often simply disabled when this type of information technology is being used, preventing users from even trying to struggle through. For example, many games can only be played in either portrait or landscape orientation and at a set zoom level. Even when the screens are very small, what is presented on the screen is most commonly simply shrunk, often becoming too small for many users to see comfortably.

This limits information technology use for people generally and is most problematic for those with disabilities who require zoom to access information technology due to visual impairments or who cannot easily change their display orientation due to mobility impairments.

### SUMMARY

Embodiments of the present disclosure present rendered worlds substantially without the problems common when a variety of zoom levels, screen sizes and screen orientations are used with prior art, problems such as a user missing important information or getting lost in empty space.

### Advantages

The subject of this disclosure allows more users with visual impairments to participate in more static, animated and/or interactive rendered worlds (such as video game worlds, simulated environments, and sociological maps) and provides a better more flexible user experience for other users with and without disabilities as well.

Through this disclosure, each scene (i.e. what is rendered on a screen given the user's chosen screen size and zoom level) is optimized for game play, interaction and/or interpretation, often without the need to reference the content of other scenes.

### DESCRIPTION OF THE DRAWINGS

FIG. 1A (Prior Art) shows a simplified representation of the rendered worlds discussed in this document.

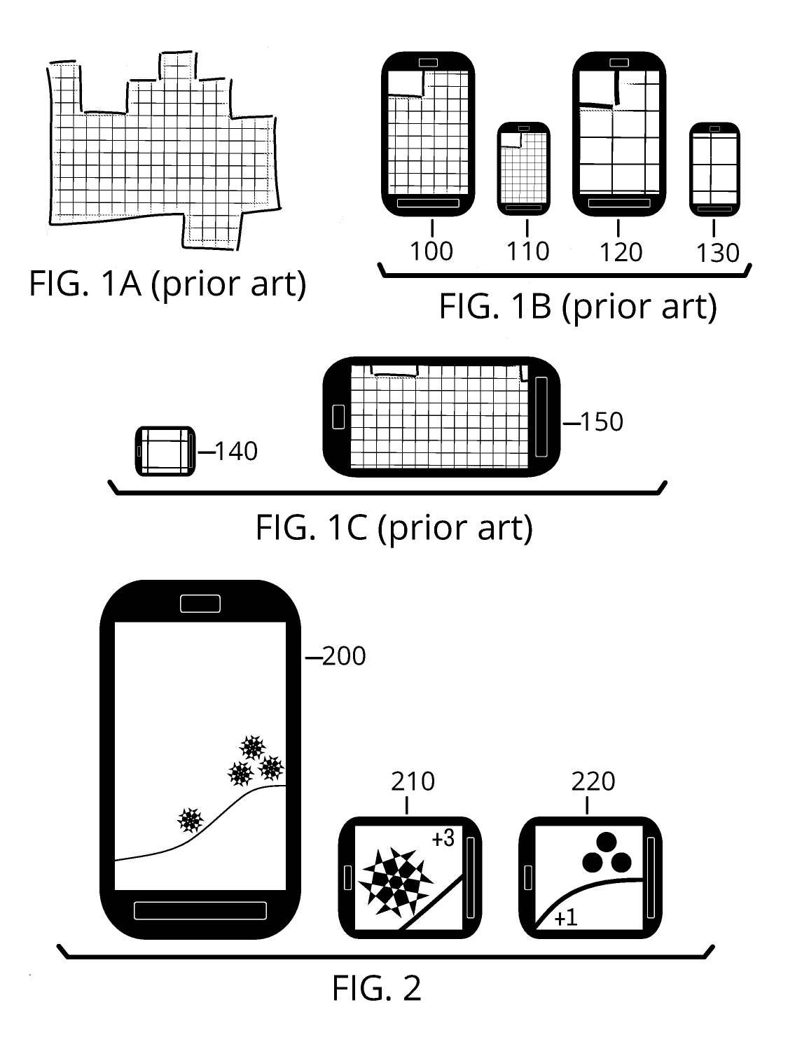

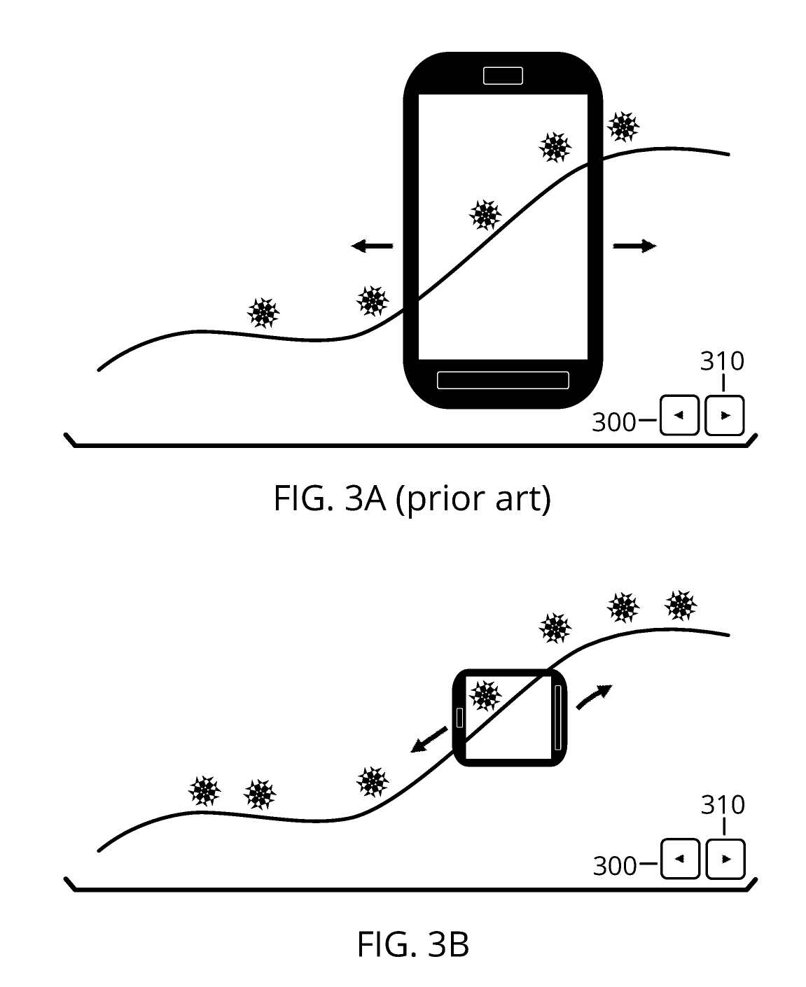

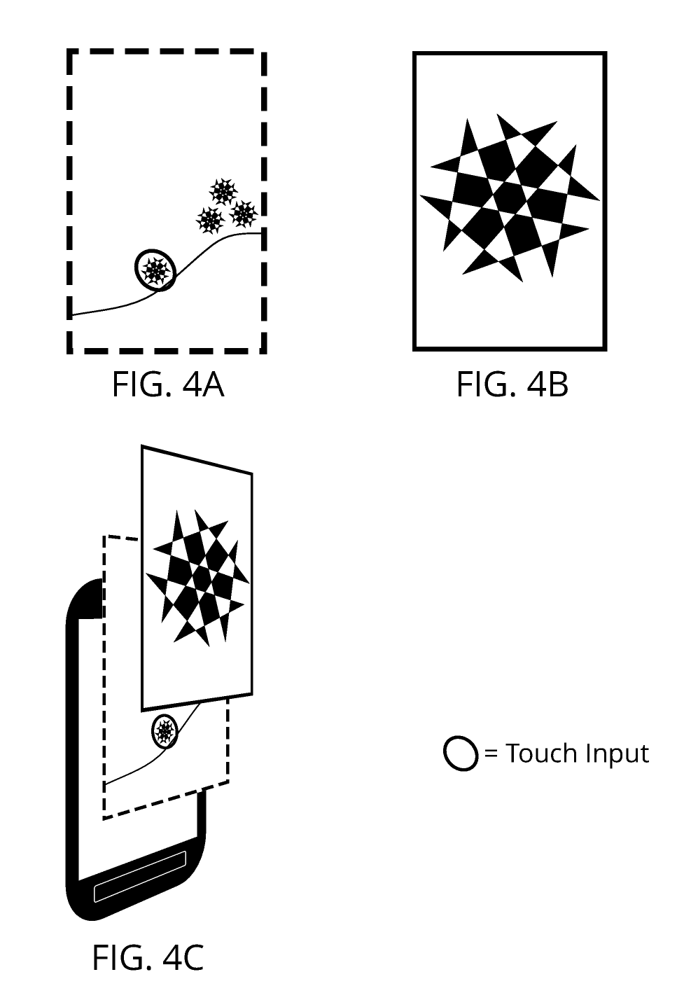

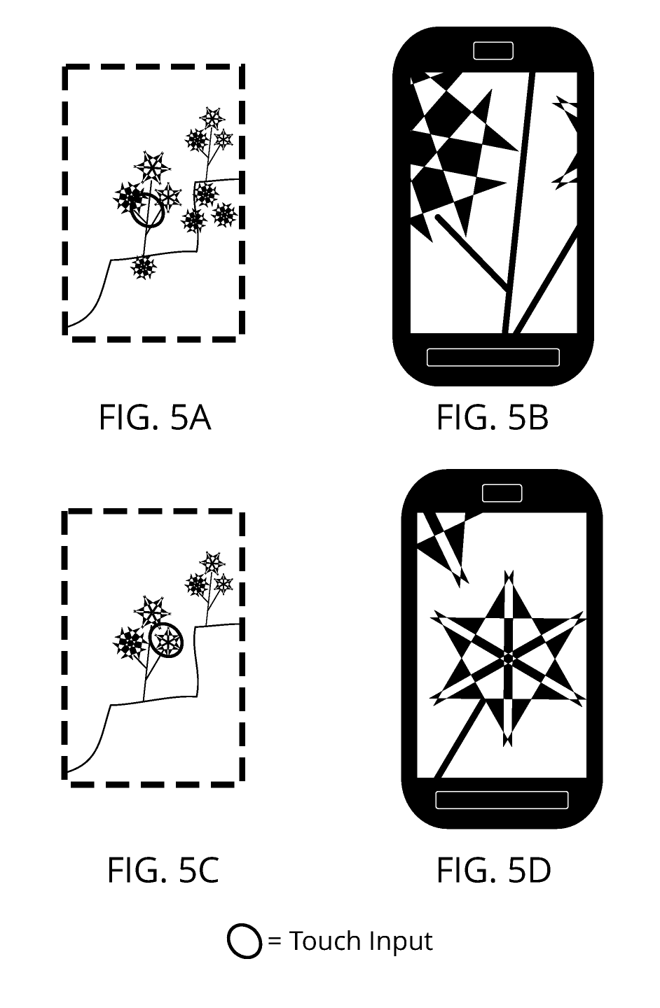

FIG. 1B (Prior Art) shows that a portion of the rendered world shown in FIG. 1A is shown on a user's screen, and that the amount of the world shown varies based on screen size and zoom level.
a. 100 shows a portion of the rendered world from FIG. 1A on a smart phone
b. 110 shows the same portion of the rendered world from FIG. 1A, but on a smaller smart phone. The content is rendered at a smaller size and in some cases like this some people won't be able to see all of the detail.
c. 120 shows a smart phone that is the same size as the phone shown in 100 but set to an increased zoom level. A person using this configuration will see less of the world on the screen at once compared with a person using the configuration shown in 100.
d. 130 shows a smart phone that is smaller than that shown in 120, but at the same zoom level. A person using this configuration will see even less of the world on the screen at once compared with a person using the configuration shown in 120.

FIG. 1C (Prior Art) shows that, compared with 1B, additional amounts more or less of the representation shown in FIG. 1A appear on screen because of screen proportions and orientation.
a. 140 shows a small device, like a watch, at the same zoom level as shown in 120 and 130. Very little of the world is shown.
b. 150 shows a larger device in landscape mode at the same zoom level used in 100 and 110. Compared with 100 and 110, 150 shows a different and larger portion of the representation shown in FIG. 1A.

FIG. 2 shows three scenes that might result from a simple embodiment of the present disclosure. The visual presentation is adjusted for different screen sizes and zoom levels. The details of such adjustments will vary as much as rendered worlds themselves vary, so the adjustments shown here are only examples. In 200, we see four game pieces. But, in 210, there is not enough space to show all of the game pieces, so the three game pieces that exist to the upper right in 200 are represented by “+3” in the upper right of the screen. In 220, we have moved up to the three game pieces that had been indicated by “+3” and we see how they are represented by simpler visuals in order to fit on the screen. Also in 220, the first game piece is indicated by a “+1” in the lower left, indicating that it is still there.

FIG. 3A (Prior Art) shows an example game with ordinary left and right motion or scrolling. The arrows show the relative motion between the rendered world and the device screen. To make FIG. 3B easier to understand, the arrows are associated with the device. In actual practice, the rendered world appears to move, while the user holds the device or watches a monitor.
a. 300 and 310 show the keyboard keys that might be used to activate this motion in configurations that include a keyboard

FIG. 3B shows the same example game as shown in FIG. 3A with assistive left and right motion or scrolling activated. The motion is not following a character or directed up, down, left and right by the person playing the game. Instead, the directions left and right have been redefined to follow a path.
a. 300 and 310 show the keyboard keys that might be used to activate this motion in configurations that include a keyboard

FIG. 4A shows an invisible touch layout, for use with “projection zoom”

FIG. 4B illustrates an embodiment of projection zoom by showing how the device screen would look when the touch layout from FIG. 4A is present. What is shown visually on screen is based on where the user is touching the screen, in other words based on the “touch input” shown in FIG. 4A.

FIG. 4C further illustrates an embodiment of projection zoom by showing two layouts on one device screen. Projection zoom allows simultaneous use of a lower zoom level (as in FIG. 4A) where more can fit on the screen and a higher zoom level (as in FIG. 4B) where more visual detail is available.

FIGS. 5A-5D illustrate an embodiment of projection zoom with panning. Instead of showing the entire item under touch input, which would be a plant with three flowers in this example, part of the item is shown. FIGS. 5A and 5C show the invisible touch interface with two slightly different touch input locations. FIGS. 5B and 5D show how the change in touch input location pans the projected zoom image.

### GLOSSARY

assistive directional motion (new terminology associated with claim 2)

when the effects of common motion commands, such as up, down, left and right or compass points are adapted in consideration of
a) the screen size to world size ratio and
b) the content in the world

in order to keep users on the most relevant paths needed to explore a rendered world or to accomplish tasks in a rendered world

programmatically laid out scene (new terminology associated with claim 1)

a scene that was composed by computer software based on a set of adjustability rules and a set of user experience rules

projection zoom (new terminology associated with claim 3)

visual access at a higher zoom level that is separated from non-visual spatial touch access at a lower zoom level, so that the visual access is a projection of the item currently in focus through the touch access (See FIGS. 4A-4C)

projection (as used in this disclosure)

a visual representation of an item selected for projection zoom. This can be any visual including, for example, an image, an animation or a slide show.

rendered world (as used in this disclosure)

a static, animated and/or interactive world (such as a video game world, simulated environment, or sociological map) created using information technology, which may be two-dimensional, three-dimensional, or some dimension level in between and can be any shape and any size

scene (as used in this disclosure)

a portion of a rendered world shown on a screen given the user's chosen screen size and zoom level

screen size to world size ratio (as used in this disclosure)

the percent of a rendered world that is shown in each scene given the user's chosen screen size and zoom level

user (as used in this disclosure)

a person who is using the rendered world for its intended purpose. For example, a player of a video game would be the video game's user.

### DETAILED DESCRIPTION

### Rendered Worlds—Prior Art FIG. 1

The rendered worlds improved by this disclosure use two-dimensional rendering, three-dimensional rendering, or some dimension level in between and can be any shape and any size, including sizes that are hundreds or thousands of multiples of the screen size.

FIG. 1A shows a representation of such a rendered world, according to one embodiment which presents a two-dimensional world.

As shown in FIG. 1B 100, part of the rendered world is shown on a user's screen. More or less of the rendered world might appear on screen because of:
a smaller screen size through hardware (110)
a smaller screen size through software, where only a portion of the physical screen is used to render the world
a higher zoom level (120)
or both a smaller screen (hardware or software) and a higher zoom level (130)

As shown in FIG. 1C, additional amounts more or less of the world or graphic might appear on screen because of hardware or software screen proportions (140) and/or because of the orientation of the software or hardware screen, such as a device in landscape versus portrait mode (150).

### Programmatically Laid Out Scenes—the Subject of Claim 1 and FIG. 2

In embodiments of programmatically laid out scenes, each scene is programmatically laid out on the screen space available and at the user's desired zoom level to ensure a scene optimized for game play, interpretation and/or interaction and to provide any important context. This is accomplished through a set of adjustability rules and a set of user experience rules.

For example, for a particular embodiment, a user experience rule might be: “No mushrooms can appear partly in the scene and partly out of the scene as a result of screen size to world size ratio changes.” And an adjustability rule might be: “Any mushroom can be moved left or right by up to one half its width and up or down by up to one half its height.” A computer instruction can then be written that will use the adjustability rule to satisfy the usability requirement. In pseudo-code, this could be written as follows:

When there is a change in the screen size to world size ratio:
For each mushroom:
   If 49% or less of the game item is on screen:
      Move the game item entirely off screen
   If more than 49% of the game item is on screen:
      Move the game item entirely on screen

### A Set of Adjustability Rules

For each embodiment, a set of objects, properties and features are considered essential and an additional set of objects, properties and features are considered adjustable. The objects, properties and features that are considered adjustable have set qualities that can and can't be adjusted. In addition, possible adjustments often have restrictions on the extent of the adjustment.

The set of possible adjustments for each embodiment will vary greatly, just as the rendered worlds to which they apply vary greatly. Allowed adjustments will commonly include:
Items that are decorative and can be removed or simplified
Items whose positions can be shifted
   The extent to which these positions can be shifted
Items that can be replaced with simpler representations. For example, in FIG. 2 200, we see three detailed game items on top of a slope. In FIG. 2 210, these are represented by “+3” presented in the upper left corner. And, in FIG. 2, 220, these are represented by 3 solid circles.
   A set of alternative representations that can be used for each such item
Items that can be added to provide greater context, such as additional user interface items or cues

Adjustability rules may also be derived from other advances described in this declaration. These are mentioned here but are described in detail in their respective sections of the present declaration. Allowed adjustments will commonly include:
Assistive Directional Motion can be used
   Allowed paths for assistive directional motion
Projection Zoom can be used
Projection Zoom with Panning can be used
   Allowed extent of the panning

### A Set of User Experience Rules

In addition, embodiments will have a given set of user experience requirements or rules to be applied to each scene. Some of these user experience rules will be based on conditions that directly trigger allowed adjustments. Examples of these conditions include:
Particular screen size to world size ratios (FIG. 1B)
Particular screen proportions (FIG. 1C)
User preferences

For example, if the screen size to world size ratio is below a certain limit, all game pieces might use a simpler representation (FIG. 2 220).

Other user experience rules will take custom forms such as:
Which items can span the borders of scenes
The minimum and maximum number of playable items on a scene
The distances certain items should be from each other

### Recommendation

A recommended approach is to configure the adjustability rules based on what the average person is likely to think about, remember and/or discuss. For example, one can easily imagine a game where a user is likely to remember, think about, and discuss finding a hidden item in a game, but where a user is not likely to remember, think about, or discuss whether two game items were 20 versus 40 pixels apart from each other.

In this way, a consistent world is presented, allowing communication and sharing about the rendered world between users using different access methods. This consistency also allows an individual to easily access the rendered world using different access methods at different times.

As mentioned, the set of objects, properties and features that are considered adjustable, though, will vary greatly between embodiments. For example, while in many cases 20 pixels difference in position will be considered an allowable adjustment, one can imagine an infographic where a particular 20 pixels of space is significant and would inspire thought and discussion.

### Assistive Directional Motion—the Subject of Claim 2 and FIG. 3

Embodiments of assistive directional motion will impact how users or characters move within a rendered world. In most embodiments, directional motion will be in straight lines for the most commonly used screen sizes and zoom levels. In other words, left, right, up, down and compass points will result in motion in exactly those directions, as shown in FIG. 3A.

However, in some configurations and especially as the screen size to world size ratio shrinks relative to the configuration used for the original design, this can cause problems. Users can move directly into empty space, for example. Observe that in FIG. 3B, moving strictly to the left or to the right would eventually cause only empty space to be shown.

As shown in FIG. 3B, assistive directional motion solves this issue by providing a path to guide directional motion. This path can be predetermined by human designers, especially if there is a line in the world that would work such as a ground line, or can be created programmatically for example by
plotting the points of interest where there are key items that should not be missed
defining a path composed of a set of lines through these points
smoothing the path

When items are clustered together they can often be considered one point of interest for the purposes of creating a path to use with assistive motion. And, assistive directional motion will often be suspended in areas with many points of interest, resuming again when the user departs those areas of the rendered world.

In FIG. 3B, with a smaller screen using the same embodiment as shown in FIG. 3A, movement is adjusted based on the content shown and follows the shape of the ground-line, so that the user will see the important game content.

When the rendered world is more complex, users might choose topics of interest to further refine the directional motion paths. For example, if the rendered world is a geographic map displaying data such as population density and pollution levels, assistive directional motion can allow the user to travel the map by topic. For example, a user may wish to travel by a path designed to bring the user through regions with high pollution levels.

Users of high zoom levels and/or very small screen sizes, such as smart watches, will benefit from assistive directional motion in many types of rendered worlds.

Assistive directional motion can also help with entirely non-visual access. For example, if a game includes positional audio, it may be quite easy to get lost if there are many items quite distant from the user's current position. In other words, if the user is in empty space. Presenting the positional audio as though the user is more zoomed in and using assistive directional motion to keep the user near items can make what might be an unwieldy experience quite manageable.

### Projection Zoom—the Subject of Claim 3 and FIG. 4

When zoom levels exceed the ability to effectively layout scenes and especially when the embodiment includes a touch screen, projection zoom may be used. In projection zoom, there are two scene layouts. One or both of these may be programmatically laid out scenes as discussed above, but that is not necessary. A more detailed scene is used for touch input while a less detailed scene is used for visual output.

### The More Detailed Scene and Some Background

The more detailed scene is the sort of touch scene that can be used entirely non-visually as is done in prior art for access to touch screens for users with visual impairments. The user moves their finger or a stylus around the screen and hears audio and may feel haptics based on what they touch. A user can, for example, remember the layout and directly access, for example, a button at the top left of the screen, even if they cannot see the screen. Sometimes, for privacy, users will use this while displaying only a blank screen.

### The “Projection”

Projection zoom takes advantage of the unused visual space and shows visuals based on the item the user is currently pointing to in the touch interface. See FIG. 4. Projection zoom allows the user to take advantage of the more detailed touch scene's spatial layout, while also having access to visual output at a high zoom level. This projection will often be a close up of a static item. But, the projection can present time-based media such as an animation, a series of images, an animation that pans around an image or even a slideshow that accepts additional input, such as a speech command, to move between slides.

### Best Practices

Some embodiments will want to ensure that transitions between the visual projections are animated or gradual to avoid jarring or flashing effects.

Some embodiments may even want to ensure that transitions between the visual projections only occur when the user provides additional input, such as pausing on the item for a time after the sound effects, haptic effects and/or screen reader speech have either ended or started to repeat, issuing a speech command, or using increased touch pressure.

Some embodiments will benefit from using the projection to present an animation to act as a tutorial for items or item types when they are first shown through projection zoom.

Projection Zoom with Panning—the Subject of Dependent Claim 4 and FIG. 5

Sometimes, even with projection zoom, the level of zoom will exceed the ability to show an entire item on screen at once. As has become a theme in this disclosure, this can be because of an extra high level of zoom and/or an extra small screen. In this case, panning can allow the user to see the full item.

Another reason for panning would be for an item that is especially large in the scale of the world, such as a boss at the end of a game level.

So, some embodiments will use the local motion of touch to pan around the projected image, as shown in FIG. 5.

When projection zoom is active, panning can be provided by default for all items or just for particular items. For example, in FIG. 5, the items shown on screen are compound and made up of some of the items from FIG. 4. If this happened in an advanced level of a game that used the projection zoom shown in FIG. 4 for earlier levels, panning could be introduced along with the compound items to allow the user to take in the full compound item.

Alternatively, in some embodiments, each item will be shown centered on screen regardless of its size in the scale of the world. Then, users will be required to request additional zoom and panning, through some simple input, such as a voice command or pressing the screen with extra pressure.

What is claimed is:

1. A system comprising a configuration of hardware and software that will allow users to navigate and explore a rendered world characterized in that said system produces a graphical user interface that allows navigation and exploration at any of
a range of zoom levels,
a range of display orientations,
a range of software display sizes,
a range of hardware display sizes,
because each scene that presents a portion of the rendered world is programmatically laid out with intentionality given the user's chosen screen size and zoom level through a set of adjustability rules implemented through programming logic to meet a set of user experience rules
whereby each scene is optimized for interaction and interpretation.

2. A system comprising a configuration of hardware and software that will allow users to navigate and explore a rendered world characterized in that the path of directional motion changes
based on the user's screen size to world size ratio and in consideration of the content displayed in said rendered world
whereby people who navigate and explore said rendered world will be assisted in finding relevant items.

3. A system comprising a configuration of hardware and software that will allow users to navigate and explore a rendered world, characterized in that, when the user's screen size to world size ratio becomes too small to show sufficient context, visual access is separated from non-visual touch access and the visual display is used as a projection of whichever item is chosen through the non-visual touch access
whereby users can take advantage of the more detailed touch scene's spatial layout, while also having access to visual output at a high zoom level.

4. A system as described in claim 3 that allows the user to pan around said projection.
